(19) United States
(12) Patent Application Publication
(10) Pub. No.: US 2006/0159006 A1
(43) Pub. Date: Jul. 20, 2006

(54) Apparatus and method for reducing an error vector magnitude in an orthogonal frequency division multiplexing receiver

(75) Inventors: Hae-Dong Yeon, Bucheon-si (KR); Jae-Yong Lee, Seongnam-si (KR); Yun-Sang Park, Suwon-si (KR); Bong-Gee Song, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/333,460

(22) Filed: Jan. 17, 2006

(30) Foreign Application Priority Data
Jan. 17, 2005 (KR) 2005-4338

(51) Int. Cl. H04J 11/00

(52) U.S. Cl. 370/208; 370/210

(57) ABSTRACT

An apparatus and a method for reducing an error vector magnitude in an orthogonal frequency division multiplexing (OFDM) receiver. The method includes the steps of inputting a receiving symbol including a guard interval and an effective symbol interval following the guard interval, in which a front portion of the guard interval and a rear portion of the effective symbol interval have windowing intervals corresponding to windowing of a transmitter, and replacing a signal of the rear windowing interval with a signal of an interval between the front windowing interval and the effective symbol interval, thereby outputting a signal of the effective symbol interval, which substitutes for a signal of the rear windowing interval, to a fast Fourier transform (FFT) section.

### PRIORITY

This application claims priority to an application entitled “Apparatus And Method For Reducing Error Vector Magnitude In Orthogonal Frequency Division Multiplexing receiver” filed with the Korean Intellectual Property Office on Jan. 17, 2005 and assigned Serial No. 2005-4338, the content of which is incorporated herein by reference.

### BACKGROUND OF THE INVENTION

1. Field of the Invention

The present invention relates generally to an orthogonal frequency division multiplexing (OFDM) system, and more particularly, to an apparatus and a method for reducing an error vector magnitude (EVM) in an OFDM receiver.

2. Description of the Related Art

In an OFDM scheme, a data stream having a high transmission rate is divided into various data streams having a low transmission rate. The data streams are simultaneously transmitted in parallel to each other using a plurality of sub-carriers. Such an OFDM scheme has a high data rate, superior frequency efficiency and superior characteristics against a frequency fading channel.

In order to prevent orthogonality between sub-carriers from being broken due to channel characteristics, a guard interval, which is longer than a delay spread of a channel, is inserted between OFDM symbols (hereinafter, referred to as “symbols”), thereby removing inter-symbol interference (ISI).

In addition, in order to ensure continuity over all symbol intervals including the guard interval, a cyclic prefix (CP) is inserted into the guard interval. That is, a part of the symbol is copied as a CP and the CP is insert into the guard interval.

In addition, the guard interval having the CP is located at a front part of the symbols such that the symbols are cyclically extended, thereby preventing an inter-carrier interference (ICI).

Further, the OFDM scheme achieves a parallel transmission of sub-carriers by using an inverse fast Fourier transform (IFFT) of a transmitter and a fast Fourier transform (FFT) of a receiver. Accordingly, each sub-carrier of an OFDM signal includes a sinc function to overlapped the sub carriers with each other while maintaining the orthogonality therebetween. Because of the sinc function characteristics, the OFDM signal is not band limited. That is, the OFDM signal causes interference between adjacent bands.

In order to reduce interference between adjacent bands, a transmission scheme has been suggested in which data is transmitted to sub-carriers with the exception of some of sub-carriers of a frequency band. That is, signals are not transmitted to some sub-carriers located at both ends of a corresponding frequency band. However, because the sinc function has a relatively high side lobe, the number of sub-carriers, which do not receive the data, must be increased in order to remove the interference between the adjacent bands through the above transmission scheme. In this case, frequency efficiency is significantly degraded.

Consequently, a time windowing scheme has been suggested to reduce the interference between adjacent bands while properly maintaining frequency efficiency. The side lobe of the sinc function can be effectively reduced through the time windowing scheme. A raised cosine window is commonly used as a window of the time windowing scheme.

A raised cosine windowing scheme using the raised cosine window includes a 1 symbol interval raised cosine windowing scheme (hereinafter, referred to as “1 symbol interval windowing”) and a 3 symbol interval raised cosine windowing scheme (hereinafter, referred to as “3 symbol interval windowing”).

FIG. 1 illustrates the 1 symbol interval windowing. Referring to FIG. 1, Tₛ is a symbol period representing 1 symbol interval, T_{g} is a guard interval, and T_{b} is an effective symbol interval. In FIG. 1, one symbol includes the guard interval T_{g} and the effective symbol interval T_{b} following the guard interval T_{g}. As described above, the guard interval T_{g} is inserted into the symbol as the CP by copying a rear portion of the effective symbol interval T_{b}.

If a time domain OFDM signal is x(n), a transmission signal s(n), which is obtained by applying the 1 symbol interval windowing to the x(n), is represented as shown in Equation (1).
s(n)=w(n)×x(n), for 0≦n≦Nₛ−1 (1)

In addition, a time window coefficient w(n) is defined as Equation 2.

$$w ( n ) = \{ \begin{matrix}0.5 \times ( 1 + cos ( π \times ( 1 + \frac{n}{m} ) ) ) , \\ 0.5 \times ( 1 + cos ( π \times \frac{n - ( ( {N}_{s} - 1 ) - m )}{m} ) )\end{matrix} \qquad ( 2 )$$

wherein, 0≦n<m, m≦n<Nₛ−m, and Nₛ−m≦n≦Nₛ−1.

In Equations (1) and (2), Nₛ is a number of time samples for the symbol period Tₛ and m is a window size.

Referring to Equations (1) and (2), in a transmitter of an OFDM system, with respect to a signal having the symbol period Tₛ as illustrated in FIG. 1, an interval between a start point of the symbol and the window size m is multiplied by

$$0.5 \times ( 1 + cos ( π \times ( 1 + \frac{n}{m} ) ) ) ,$$

an interval between the window size m and Nₛ−m is multiplied by 1, and an interval between Nₛ−m and an end of the symbol is multiplied by

$$0.5 \times ( 1 + cos ( π \times \frac{n - ( ( {N}_{s} - 1 ) - m )}{m} ) ) ,$$

thereby achieving the 1 symbol interval windowing.

Because the interval between the window size m and Nₛ−m is multiplied by 1, the signal is identical to the original signal. An interval between the front window size m and the rear window size m is a windowing interval that causes distortion to the original signal through the actual windowing.

In the following description, the interval of the front window size is called a “front windowing interval” and the interval of the rear window size is called an “rear windowing interval” for one symbol.

FIG. 2 illustrates a 3 symbol interval windowing scheme. Referring to FIG. 2, Tₛ is a symbol period representing 1 symbol interval, T_{g} is a guard interval, and T_{b} is an effective symbol interval. According to the 3 symbol interval windowing scheme, a previous symbol signal is overlapped with a prefix portion T_{prefix} of a present symbol and a post symbol signal is overlapped with a postfix portion T_{postfix} of the present symbol.

If a time domain OFDM signal is x(n), a transmission signal s(n), which is obtained by applying the 3 symbol interval windowing to the x(n), is represented as shown Equation (3).

$$s ( n ) = w ( n ) \times {\sum }_{{k = - {N}_{used} / 2}_{k \neq 0}}^{{N}_{used} / 2} {b}_{k} exp ( ( j 2 π k Δ f ) ( n - {N}_{g} ) ) , for - m \leq n \leq {N}_{s} + m \qquad ( 3 )$$

In addition, a time window coefficient w(n) is defined as Equation 4.

$$w ( n ) = \{ \begin{matrix}0.5 \times ( 1 + cos ( π \times ( 1 + \frac{n + m}{2 m} ) ) ) , \\ 0.5 \times ( 1 + cos ( π \times \frac{n - ( {N}_{s} - m )}{m} ) )\end{matrix} \qquad ( 4 )$$

wherein, −m≦n<m, m≦n<Nₛ−m, and Nₛ−m<n≦Nₛ+m.

In Equations (3) and (4), Nₛ is a number of time samples for the symbol period Tₛ and m is a window size. In addition, bₖ is a frequency domain signal transmitted from a k^{th} sub-carrier, N_{g} is a number of time samples for the guard interval T_{g}, and N_{used} is a number of sub-carriers corresponding to ang IFFT size, except for virtual carriers, which do not transmit the signal. That is, N_{used} identifies the number of sub-carriers that can receive the pilot or data among the sub-carriers corresponding to the IFFT size.

Because the windowing scheme intentionally causes distortion to the signal, an error vector magnitude of a system may be degraded and hardware complexity may be increased due to the windowing scheme. In particular, although the 1 symbol interval windowing scheme can be easily achieved while significantly reducing the side lobe, it may exert a bad influence upon EVM performance of the system.

The EVM is defined as shown Equation 5 and is used to measure a preciseness of modulation of the transmitter. In addition, the EVM, together with a spectrum mask, is an important parameter for achieving a transmission system and must satisfy conditions defined by the standard of the OFDM system.

$$EVM = \sqrt{\frac{\frac{1}{N} {\sum }_{1}^{N} ( Δ {I}^{2} + Δ {Q}^{2} )}{{S}_{max}^{2}}} \qquad ( 5 )$$

In Equation (5), Sₘₐₓ² is an outermost portion of a constellation point, i.e., a constellation point having a greatest magnitude, ΔI²and ΔQ² are error vectors of a real number axis and an imaginary number axis, i.e., error vectors of an in-phase axis and a quadrature phase axis, and N is a number of sub-carriers.

FIG. 3 illustrates an EVM simulation result according to the window size of the 1 symbol interval windowing scheme, in which the window size m is represented as 4, 8, 12, 16, 24, and 32, with respect to transmission signals of a quadrature phase shift keying (QPSK) scheme and a 16-quadrature amplitude modulation (QAM) scheme. Referring to FIG. 3, the EVM becomes degraded as the window size m increases. Accordingly, the 1 symbol interval windowing scheme does not satisfy the condition of the EVM.

In contrast, although the 3 symbol interval windowing scheme does not significantly degrade the EVM as compared with the 1 symbol interval windowing scheme, it is difficult to realize the 3 symbol interval windowing scheme. That is, according to the 3 symbol interval windowing scheme, it is necessary to know the signal of the next symbol in order to transmit the present symbol. Consequently, a processing delay of a 1 symbol interval may occur, increasing a control logic and a buffer size. Accordingly, the 3 symbol interval windowing scheme may increase the necessary hardware complexity.

### SUMMARY OF THE INVENTION

Accordingly, the present invention has been designed to provide an apparatus and a method for reducing an EVM with a relatively simple structure.

According to an aspect of the present invention, there is provided a method of reducing an error vector magnitude in an orthogonal frequency division multiplexing (OFDM) receiver. The method includes the steps of: inputting a receiving symbol including a guard interval and an effective symbol interval following the guard interval, in which a front portion of the guard interval and a rear portion of the effective symbol interval have windowing intervals corresponding to windowing of a transmitter; and replacing a signal of the rear windowing interval with a signal of an interval between the front windowing interval and the effective symbol interval, thereby outputting a signal of the effective symbol interval, which substitutes for a signal of the rear windowing interval, to a fast Fourier transform (FFT) section.

### BRIEF DESCRIPTION OF THE DRAWINGS

The above and other features and advantages of the present invention will be more apparent from the following detailed description taken in conjunction with the accompanying drawings, in which:

FIG. 1 is a schematic view illustrating a conventional 1 symbol interval raised cosine windowing scheme;

FIG. 2 a schematic view illustrating a conventional 3 symbol interval raised cosine windowing scheme;

FIG. 3 is a graph illustrating an EVM simulation result of a signal according to the 1 symbol interval raised cosine windowing scheme;

FIG. 4 is a graph illustrating a spectrum simulation result of a signal according to the 1 symbol interval raised cosine windowing scheme;

FIG. 5 is a block view illustrating an OFDM receiver according to an embodiment of the present invention;

FIG. 6 is a schematic view illustrating a symbol realignment process according to an embodiment of the present invention;

FIG. 7 is a flowchart illustrating a symbol realignment process according to an embodiment of the present invention; and

FIG. 8 is a graph illustrating bit error rate (BER) performance according to an embodiment of the present invention.

### DETAILED DESCRIPTION OF THE PREFERRED EMBODIMENT

Preferred embodiments of the present invention will be described in detail hereinafter with reference to the accompanying drawings. In the following detailed description, a detailed description of known functions and configurations incorporated herein will be omitted when it may obscure the subject matter of the present invention.

According to the present invention, the 1 symbol interval windowing scheme is applied to a transmitted symbol. Thus, the windowing scheme and the window coefficient in the transmitter are identical to those of the above 1 symbol interval windowing scheme. Accordingly, the structure of the transmitter is identical to the system using the 1 symbol interval windowing scheme.

Accordingly, a spectrum of the transmitter is identical to a spectrum according to the 1 symbol interval windowing scheme.

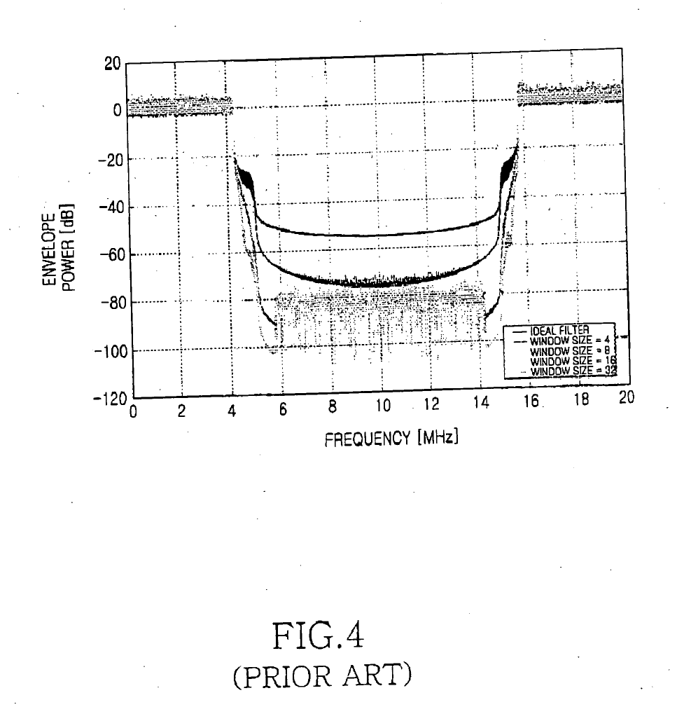

FIG. 4 illustrates a spectrum of a signal according to the 1 symbol interval windowing scheme, in which spectrums according to a window size of a 16-QAM signal having 1024 sub-carriers are illustrated. Among 1024 sub-carriers, data is transmitted to 864 sub-carriers and remaining sub-carriers are not used in order to reduce adjacent band interference.

In addition, the windowing scheme is not applied to an ideal filter, in which a half band lowpass filter having a stop band attenuation gain of 80 dB is used as an interpolation filter in order to interpolate a transmission signal by two times.

As illustrated in FIG. 4, the stop band attenuation gain increases and an inclination degree of the side lobe steepens as the window size increases.

According to the present invention, the EVM can be completely removed by changing a structure of a receiver while obtaining such a windowing effect at a transmitter.

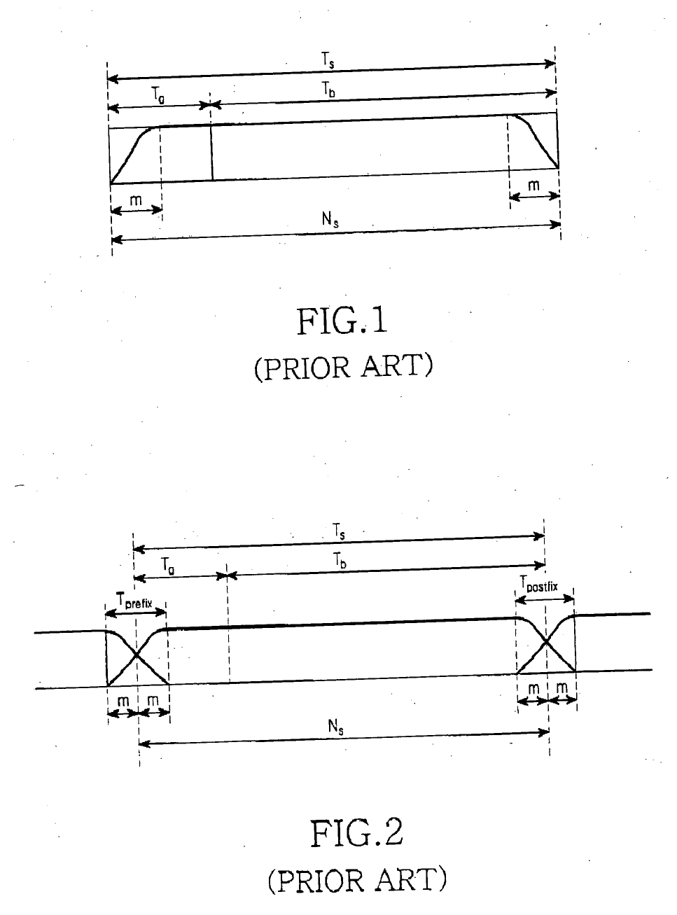

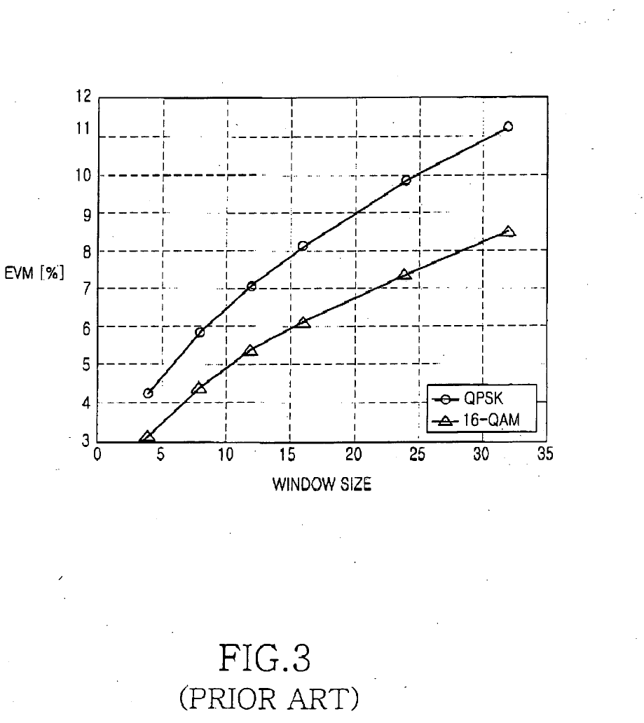

In FIG. 1, portions causing distortion to the signal due to the windowing of the 1 symbol interval windowing scheme are the front windowing interval, which is the guard interval T_{g} in which n=0 to m, and the rear windowing interval, which is the effective symbol interval T_{b} in which n=Nₛ−m to Nₛ−1. However, the signal of the guard interval T_{g} is removed at an input terminal of an FFT section of the OFDM receiver and only the signal of the effective symbol interval T_{b} is restored, such that the signal of the guard interval T_{g} does not exert an influence upon the EVM. Therefore, the signal, which undergoes the windowing in the effective symbol interval T_{b} may exert an influence upon the EVM.

In addition, the time domain signal is a basically continuous signal and the windowing signal of the effective symbol interval T_{b} is identical to the signal located at a rear portion of the CP inserted into the guard interval T_{g}. Accordingly, if the signal is realigned according to Equation (6) when removing the CP before the signal is input into the FFT section, an influence caused by the windowing can be completely removed.

$$y ( l ) = \{ \begin{matrix}r ( {N}_{g} + l ) , & for 0 \leq 1 < {N}_{FFT} - m \\ r ( {N}_{g} + l - {N}_{FFT} ) , & for {N}_{FFT} - m \leq 1 < {N}_{FFT} - 1\end{matrix} \qquad ( 6 )$$

wherein, r(n) is a receiving signal, N_{g} is a number of time samples during the guard interval T_{g}, N_{FFT} is an FFT size, and y(l) is a realigned FFT input signal.

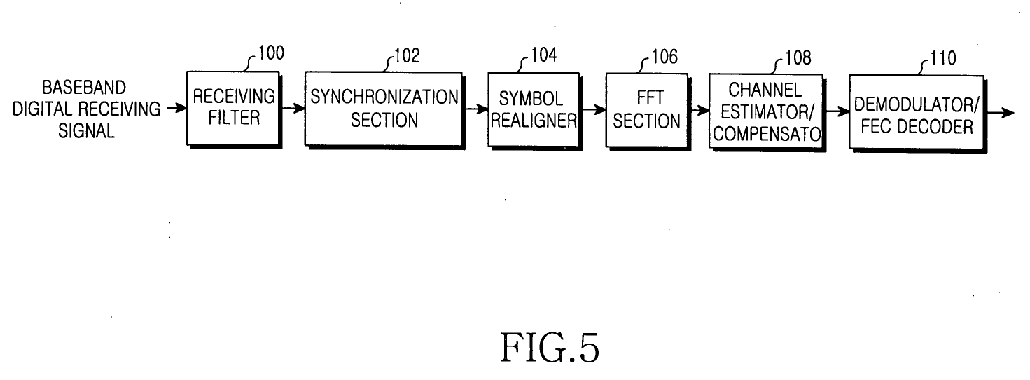

FIG. 5 is a block view illustrating an OFDM receiver according to an embodiment of the present invention. Referring to FIG. 5, the OFDM receiver includes a symbol realigner 104 aligned between a synchronization section 102 and an FFT section 106. A baseband digital receiving signal obtained from a received signal is transmitted to the synchronization section 102 through a receiving filter 100 such that the baseband digital receiving signal is frequency-synchronized with a symbol timing.

Conventionally, an output signal of the synchronization section 102 is input into a guard interval extracting section (not shown) in which the CP of the output signal is removed. Thereafter, the signal is input into the FFT section.

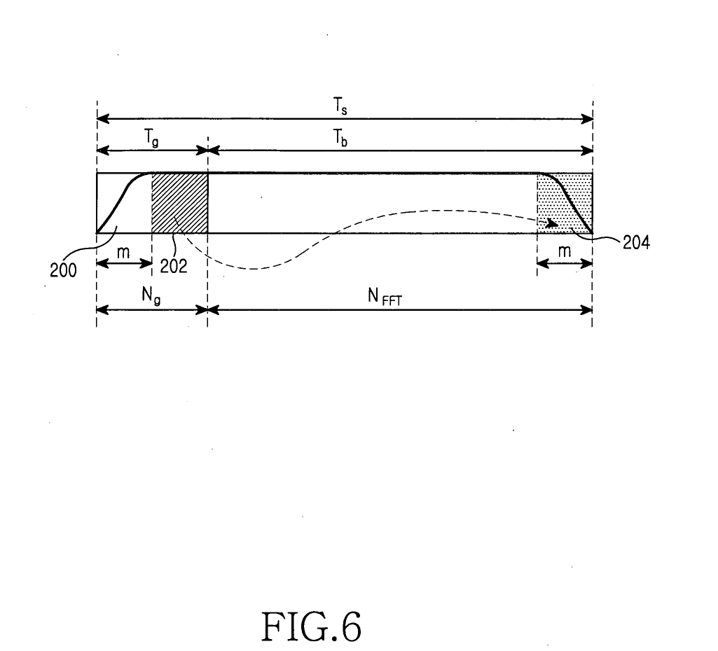

However, in the OFDM receiver illustrated in FIG. 5, the output signal of the synchronization section 102 is input into the FFT section 106 through the symbol realigner 104. The symbol realigner 104 realigns the signal according to Equation (6) and outputs a signal to be input into the FFT section 106. That is, as illustrated in FIG. 6, the symbol realigner 104 replaces the signal of a rear windowing interval 204 with a signal of an interval 202 between a front winding interval 200 of the guard interval T_{g} and the effective symbol interval T_{b}, such that the windowing signal of the effective symbol interval T_{b}, which substitutes for the signal of the rear windowing interval 204 is input into the FFT section 106.

As described above, the windowing signal of the effective symbol interval T_{b}, i.e., the signal of the rear windowing interval 204 is identical to the signal located at the interval 202 formed at a rear portion of the CP inserted into the guard interval T_{g}. Therefore, instead of the signal of the rear windowing interval 204, which is distorted due to the windowing at the transmitter, the signal of the interval 202, which is not influenced by the windowing, is transmitted to the FFT section 106, such that the bad influence caused by the windowing can be completely removed at the transmitter.

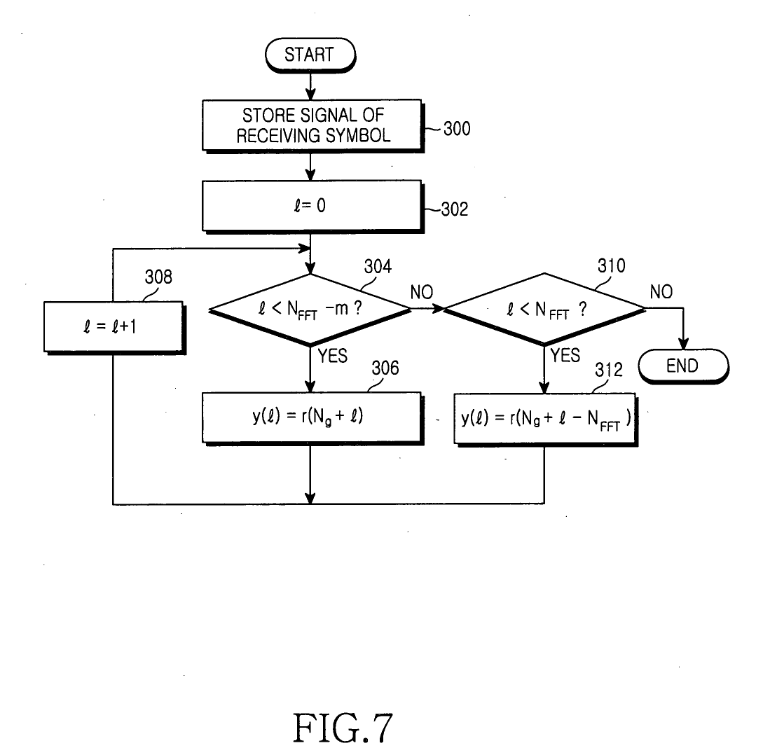

FIG. 7 is a flowchart illustrating a symbol realignment process of the symbol realigner 104, in which each symbol is processed according to Equation (6). In step 300, the symbol realigner 104 receives a signal having a receiving symbol from the synchronization section 102 and stores the signal therein. If the receiving signal is r(n), as illustrated in FIG. 6, the signal relates to the symbol period Tₛ, so n is in the range of 0 to (N_{FFT}+N_{g}−1).

In step 302, l is initialized to 0. If it is determined in step 304 that l is smaller than NFFT-m, step 306 is performed. However, if it is determined in step 304 that l is not smaller than NFFT-m, step 310 is performed.

In step 306, y(l)=r(N_{g}+l) is input into the FFT section 106. l is increased by 1 in step 308. The procedure returns to step 304.

If it is determined in step 310 that l is smaller than N_{FFT}, step 312 is performed. However, if it is determined in step 310 that l is not smaller than NFFT, the procedure may end.

In step 312, y(l)=r(N_{g}+l−N_{FFT}) is input into the FFT section 106. l is increased by 1 in step 308. Thereafter, the procedure returns to step 304.

That is, y(l)=r(N_{g}+l) is input into the FFT section 106 while continuously increasing l by 1 until l becomes N_{FFT}-m, such that the signal between the effective symbol interval T_{b} and the rear windowing interval 204, not including the signal of the guard interval T_{g}, as illustrated in FIG. 6, is input into the FFT section 106. If all of the signals between the effective symbol interval T_{b} and the rear windowing interval 204 have been output, y(l)=r(N_{g}+l−N_{FFT}) is input into the FFT section 106 while continuously increasing 1 by 1 until l becomes N_{FFT}, such that the signal of the interval 200 between the front windowing interval 200 and the effective symbol interval T_{b} is input into the FFT section 106, instead of the signal of the rear windowing interval 204.

Similarly to the conventional OFDM receiver, the signal input into the FFT section 106 may undergo the FFT. Thereafter, the signal is output to a channel estimator/compensator 108 to perform channel estimation and channel distortion compensation according to the estimated channel value. The data is restored by a modulator/forward error correction (FFC) decoder 110.

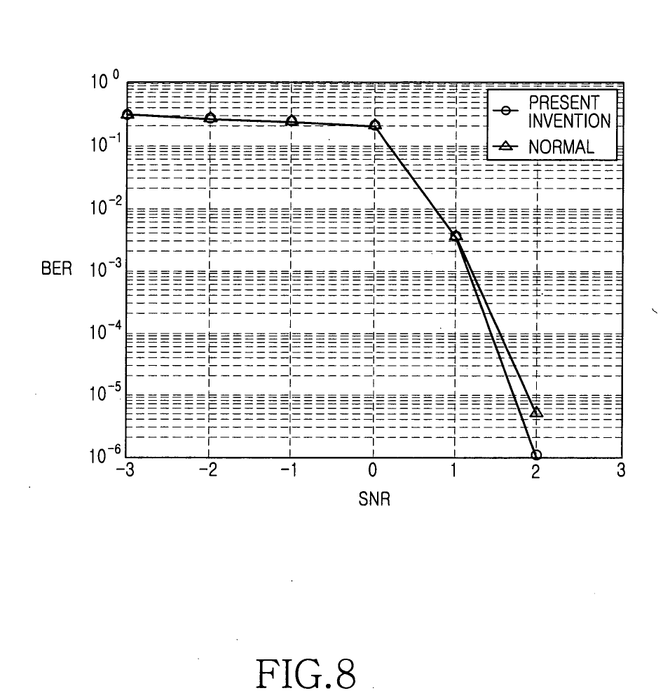

FIG. 8 is a graph illustrating bit error rate (BER) performance depending on a signal to noise ratio (SNR) of a receiver under an additive white Gaussian noise (AWGN) channel environment according to an embodiment of the present invention. The simulation environment includes an FFT size of 1024, a modulation scheme of QPSK, a convolutional turbo code (CTC) of ½ code, and a window size of 32.

As illustrated in FIG. 8, the receiver of the present invention can improve the BER performance, as compared with the receiver, which does not perform the symbol realignment, because the symbol realigner 104 can remove the signal distortion, which is intentionally caused by the windowing.

Therefore, the receiver according to the present invention prevents EVM performance from being degraded by the windowing in the ideal receiver in which the channel does not exert an influence upon the EVM.

In addition, as illustrated in FIG. 8, the BER performance, which may be degraded in the AWGN channel caused by the windowing, can be relatively improved.

Further, because the present invention uses characteristics of the OFDM signal, the present invention can be easily realized by realigning an order of the receiving signals, thereby lowering hardware complexity.

Although the present invention may reduce the guard interval of the OFDM, because the 1 symbol interval windowing scheme represents superior windowing performance, as illustrated in FIG. 4, it is sufficient to set the window size to 4 or 8. Therefore, there is no ban influence even if the guard interval of the OFDM is reduced according to the present invention.

In addition, the channel estimation can also be properly performed without limitation.

While the present invention has been shown and described with reference to certain preferred embodiments thereof, it will be understood by those skilled in the art that various changes in form and details may be made therein without departing from the spirit and scope of the present invention as defined by the appended claims.

For example, although the present invention has been described in relation to the OFDM system employing the 1 symbol interval windowing scheme, the present invention is also applicable for the OFDM system employing the 3 symbol interval windowing scheme. In this case, the signal of the postfix portion T_{postfix} is replaced with the signal of the rear portion of the guard interval T_{g} illustrated in FIG. 2, i.e., replaced with the signal of the prefix portion T_{prefix}.

In addition, the present invention is not only applicable for an orthogonal frequency division multiple access (OFDMA) system based on the OFDM, but also for systems employing the OFDM time windowing scheme in order to reduce the EVM.

What is claimed is:

1. A method of reducing an error vector magnitude in an orthogonal frequency division multiplexing (OFDM) receiver, the method comprising the steps of:
inputting a receiving symbol including a guard interval and an effective symbol interval following the guard interval, in which a front portion of the guard interval and a rear portion of the effective symbol interval have windowing intervals corresponding to windowing of a transmitter;
replacing a signal of the rear windowing interval with a signal of an interval between the front windowing interval and the effective symbol interval; and
outputting a signal of the effective symbol interval, in which the signal of the rear windowing interval is replaced, to a fast Fourier transform (FFT) section.

2. The method as claimed in claim 1, wherein the signal outputting step comprises the steps of:
outputting a signal of an interval between the guard interval and the rear windowing interval to the FFT section; and
outputting a signal of an interval between the front windowing interval and the effective symbol interval to the FFT section.

3. The method as claimed in claim 2, wherein the windowing is performed by applying a 1 symbol interval raised cosine window to the symbol.

4. An apparatus for reducing an error vector magnitude in an orthogonal frequency division multiplexing (OFDM) receiver, the apparatus comprising:
a symbol realigner for receiving a signal of a receiving symbol including a guard interval and an effective symbol interval following the guard interval, in which a front portion of the guard interval and a rear portion of the effective symbol interval have windowing intervals corresponding to windowing of a transmitter, the symbol realigner replacing a signal of the rear windowing interval with a signal of an interval between the front windowing interval and the effective symbol interval, and outputting a signal of the effective symbol interval; and
a fast Fourier transform (FFT) section for receiving the signal of the effective symbol interval and performing a FFT with respect to the signal.

5. The apparatus as claimed in claim 4, wherein the symbol realigner outputs a signal of an interval between the guard interval and the rear windowing interval to the FFT section and outputs a signal of the interval between the front windowing interval and the effective symbol interval to the FFT section.

6. The apparatus as claimed in claim 5, wherein the windowing is performed by applying a 1 symbol interval raised cosine window to the symbol.
